(19) United States
(12) Patent Application Publication
(10) Pub. No.: US 2014/0091490 A1
(43) Pub. Date: Apr. 3, 2014

(54) PROCESS FOR MANUFACTURING ARTICLES COMPRISING POLYLACTIC ACID POLYMERS HAVING IMPROVED HEAT RESISTANCE

(71) Applicant: INTERNATIONAL PAPER COMPANY, Memphis, TN (US)

(72) Inventors: Richard A. Tedford, Loveland, OH (US); Ganesan Kumar, Loveland, OH (US); Thomas Christie, Milford, OH (US)

(73) Assignee: INTERNATIONAL PAPER COMPANY, MEMPHIS, TN (US)

(21) Appl. No.: 13/644,252

(22) Filed: Oct. 3, 2012

(51) Int. Cl. C08J 5/00

(52) U.S. Cl. CPC C08J 5/00
USPC 264/138; 264/234; 264/210.1

(57) ABSTRACT

A process for thermoforming a discrete section of an amorphous pliable thermoplastic sheet in a temperature-controlled thermoforming mold to provide a discrete thermoformed section having one or more discrete shaped articles formed therein and to heat the shaped articles to a temperature below the Tₘ but above the T_{g} of the polylactic acid polymer in the sheet to induce crystallization of the polylactic acid polymer in the shaped articles. While unconstrained by the thermoforming mold, the discrete thermoformed section is tempered at a temperature such that the polylactic acid polymer in the shaped articles achieves a degree of crystallization of at least about 5% (as measured by X-ray diffraction) to thereby increase heat resistance of the shaped articles.

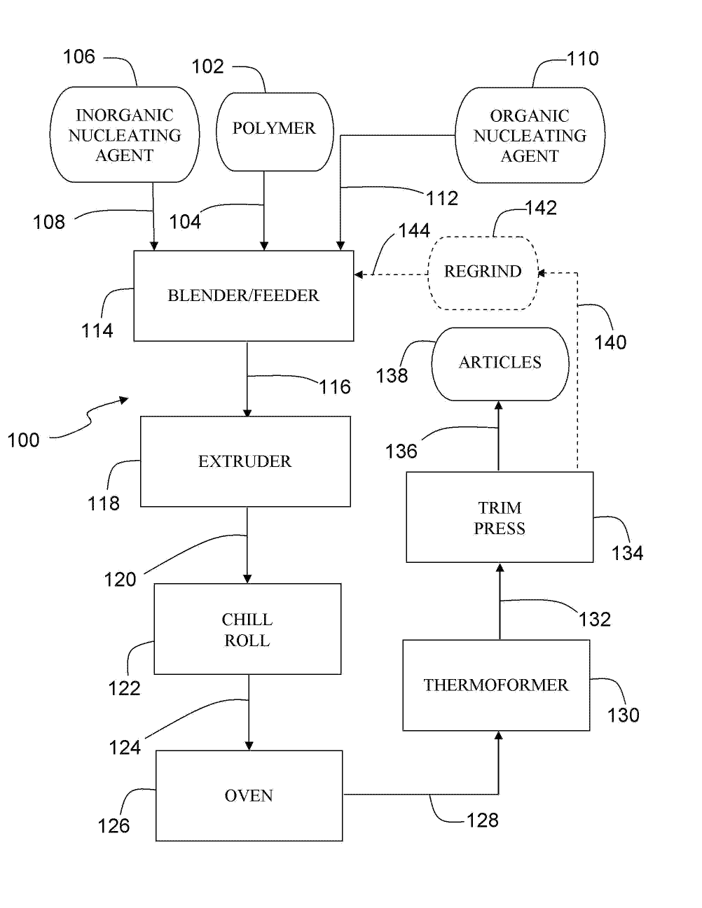

### FIELD OF THE INVENTION

The present invention broadly relates to a process for increasing the heat resistance of shaped thermoformed articles prepared from an amorphous pliable thermoplastic sheet comprising a polylactic acid (PLA) polymer. The present invention further relates broadly to a process for continuously extruding a thermoplastic sheet comprising a PLA polymer and a nucleating agent which is heated to provide an amorphous pliable thermoplastic sheet and which is incrementally advanced as discrete sections into a temperature-controlled thermoforming mold to heat the shaped articles in the thermoformed section to a temperature sufficient to induce crystallization of the PLA polymer to thereby increase the heat resistance of the shaped articles formed in each thermoformed section.

### BACKGROUND

There is growing need to substitute for petroleum-based polymer used in disposable thermoformed articles. Such disposable thermoformed articles may include food packaging, such as lids for disposable beverage cups. As a result, there has been an increased focus on using compostable polyesters, such as polylactic acid (PLA) polymers, in such disposable thermoformed articles. PLA polymers may provide good strength and ease of processability by thermoforming with favorable biodegradability. In fact, PLA may be widely used to make disposable thermoformed food packaging articles due to its compostability and environmental friendliness.

To provide disposable thermoformed articles, the PLA polymer may be initially extruded as a continuous sheet. This continuous PLA sheet may then be heated in, for example, an oven to make the PLA sheet sufficiently pliable for subsequent thermoforming. This heated PLA sheet may then be sequentially advanced to a thermoformer. The thermoformer comprises a thermoforming mold for forming a plurality of shaped articles (e.g., a plurality of disposable beverage cups, a plurality of lids for such cups, etc.) in a thermoformed section of the PLA sheet normally corresponding to the dimensions of the thermoforming mold. These shaped articles in the thermoformed section may then be detached (e.g., cut out) from the remaining unshaped portion of the thermoformed section using, for example, a trim press.

Unfortunately, thermoformed articles prepared from such PLA sheets may tend to deform when subjected to higher temperatures, for example, the temperature of hot beverages such as coffee. In other words, these thermoformed articles prepared from such PLA sheets may lack the necessary heat resistance to be suitable for handling such hot beverages. Due to this shortcoming, the commercial potential of PLA polymers may not fully realized for use in such disposable thermoformed articles.

### SUMMARY

According to a first broad aspect of the present invention, there is provided a process for increasing the heat resistance of shaped thermoformed articles made from a thermoplastic sheet, comprising the following steps:
(a) providing an amorphous pliable thermoplastic sheet comprising at least about 60% by weight of the amorphous pliable thermoplastic sheet of a polylactic acid polymer;
(b) thermoforming a discrete section of the amorphous pliable thermoplastic sheet in a temperature-controlled thermoforming mold to provide a discrete thermoformed section having one or more shaped articles formed therein and to impart to the shaped articles a temperature below the Tₘ but above the T_{g} of the polylactic acid polymer to thereby induce crystallization of the polylactic acid polymer in the shaped articles; and
(c) while unconstrained by the thermoforming mold, tempering the thermoformed section at a temperature above the T_{g} of the polylactic acid polymer such that the polylactic acid polymer in the shaped articles achieves a degree of crystallization of at least about 5% (as measured by X-ray diffraction) to thereby increase the heat resistance of the shaped articles.

According to a second broad aspect of the present invention, there is provided a process for manufacturing shaped thermoformed articles having improved heat resistance from a thermoplastic sheet, comprising the following steps:
(a) continuously extruding a thermoplastic sheet comprising at least about 60% by weight of the thermoplastic sheet of a polylactic acid polymer and a crystallization inducing amount of at least one polylactic acid polymer nucleating agent;
(b) heating the thermoplastic sheet of step (a) to a temperature at or above the Tₘ of the polylactic acid polymer to provide an amorphous pliable thermoplastic sheet;
(c) incrementally advancing a discrete section of the amorphous pliable thermoplastic sheet into a temperature-controlled thermoforming mold to provide a discrete thermoformed section having a plurality of shaped articles formed therein and to impart to the shaped articles a temperature below the Tₘ but above the T_{g} of the polylactic acid polymer to thereby induce crystallization of the polylactic acid polymer in the shaped articles;
(d) while unconstrained by the thermoforming mold, convection cooling the thermoformed section such that the polylactic acid polymer in the shaped articles achieves a degree of crystallization of at least about 5% (as measured by X-ray diffraction) to thereby increase the heat resistance of the shaped articles; and
(e) after step (d), detaching each of the shaped articles from the thermoformed section;
wherein steps (b) through (e) are performed sequentially a plurality of times.

### BRIEF DESCRIPTION OF THE DRAWINGS

The invention will be described in conjunction with the accompanying drawings, in which:

The FIGURE is a schematic diagram illustrating an embodiment of a process according to the present invention for preparing a thermoformed article comprising a polylactic acid polymer and inorganic/organic nucleating agents.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provides below, unless specifically indicated.

For the purposes of the present invention, any directional or positional terms such as “top”, “bottom”, “upper,” “lower,” “side,” “front,” “frontal,” “forward,” “rear,” “rearward,” “back,” “trailing,” “above,” “below,” “left,” “right,” “horizontal,” “vertical,” “upward,” “downward,” “outer,” “inner,” “exterior,” “interior,” “intermediate,” etc., are merely used for convenience in describing the various embodiments of the present invention. For example, the orientation of any embodiments described herein may be reversed or flipped over, rotated by 90° in any direction, etc.

For the purposes of the present invention, the term “biodegradable” refers to any organic material, composition, compound, polymer, etc., which may be broken down into organic substances by living organisms, for example, microorganisms, and includes the term “compostable.”

For the purposes of the present invention, the term “compostable” refers to an organic material, composition, compound, polymer, etc., which undergoes degradation by biological processes, such as fungal or bacterial action, or by chemical processes, such as hydrolysis (e.g., commercial composting), to yield, for example, carbon dioxide, water, inorganic compounds, biomass, etc., and which may leave no visible, distinguishable, toxic, etc., residue. Compostable materials may satisfy one or more of the following criteria: (1) disintegration (i.e., the ability to fragment into non-distinguishable pieces after screening and safely support bio-assimilation and microbial growth; (2) inherent biodegradation by conversion of carbon to carbon dioxide to the level of at least about 60% over a period of 180 days as measured by the ASTM D6400-04 test method; (3) safety (i.e., no evidence of any eco-toxicity in finished compost and soils can support plant growth); and (4) non-toxicity (i.e., heavy metal concentrations are less than about 50% of regulated values in soils). The compostability of materials, compositions, compounds, polymers, etc., used in embodiments of the present invention may be measured by ASTM D6400-04 test method, which is a standard test for determining compostability and which is herein incorporated by reference.

For the purposes of the present invention, the term “composting” refers to a process (e.g., managed process) which controls the biological decomposition and transformation of biodegradable materials into a humus-like substance called compost: the aerobic mesophilic and thermophilic degradation of organic matter to make compost; the transformation of biologically decomposable material through a controlled process of biooxidation which proceeds through mesophilic and thermophilic phases and results in the production of, for example, carbon dioxide, water, minerals, and stabilized organic matter (compost or humus).

For the purposes of the present invention, the term “renewable polymer” (also known as “biopolymer”) refers to a polymer, or a combination (e.g., blend, mixture, etc.) of polymers, which may be obtained from renewable natural resources, e.g., from raw or starting materials which are or may be replenished within a few years (versus, for example, petroleum which may require thousands or millions of years). For example, a renewable polymer may include a polymer that may be obtained from renewable monomers, polymers which may be obtained from renewable natural sources (e.g., starch, sugars, lipids, corn, sugar beet, wheat, other, starch-rich products etc.) by, for example, enzymatic processes, bacterial fermentation, other processes which convert biological materials into a feedstock or into the final renewable polymer, etc. See, for example, U.S. Pat. App. No. 20060036062 (Ramakrishna et al.), published Feb. 16, 2006, the entire disclosure and contents of which is hereby incorporated by reference, which discloses a process for producing polylactic acid (PLA) polymers from renewable feedstocks. Renewable polymers which may be useful in embodiments of the process of the present invention may include polylactic acid (PLA) polymers; polyesters other than PLA, for example, polyhydroxyalkanoate (PHA) polymers, such as polyhydroxybutyrate (PHB), polycaprolactones (PCLs); etc.

For the purposes of the present invention, the term “recyclable” refers to any material, composition, compound, polymer, etc., which may be reused, reprocessed, reincorporated, etc., wholly or partially.

For the purposes of the present invention, the term “regrind” refers to recycled residual portions of trimmed or otherwise separated thermoformed sheets that have been reground for inclusion (wholly or partially) in the starting materials (i.e., polylactic acid polymer, nucleating agents, etc.) for preparing subsequent thermoplastic sheets.

For the purposes of the present invention, the term “amorphous” refers to a solid, softened, and/or melted polymer which is not crystalline, i.e., has no lattice structure which is characteristic of a crystalline state.

For the purposes of the present invention, the term “crystalline” refers to a solid polymer which has a lattice structure which is characteristic of a crystalline state.

For the purposes of the present invention, the term “high temperature deformation-resistant material” refers to a material which resists deformation at a temperature of about 170° F. (76.7° C.) or higher, for example, about 180° F. (82.2° C.) or higher.

For the purposes of the present invention, the term “thermoforming” refers to a process for preparing one or more shaped articles from a thermoplastic sheet. In thermoforming, the thermoplastic sheet may be heated to its melting or softening point, stretched over or into a temperature-controlled single-surface or dual-surface mold and then held against or within the mold surface(s) until the thermoformed section is sufficiently solidified such that the shaped articles formed therein retain their shape when unconstrained by the mold surface(s). Thermoforming may include vacuum forming, pressure forming, etc.

For the purposes of the present invention, the term “thermoform” and similar terms such as, for example “thermoformed,” etc., refers to the forming of shaped articles from a thermoplastic sheet by a thermoforming process.

For the purposes of the present invention, the term “melting point” refers to the temperature range at which a crystalline material changes state from a solid to a liquid, e.g., may be molten. While the melting point of material may be a specific temperature, it often refers to the melting of a crystalline material over a temperature range of, for example, a few degrees or less. At the melting point, the solid and liquid phases of the material often co-exist in equilibrium.

For the purposes of the present invention, the term “Tₘ” refers to the melting temperature of a polymer. The melting temperature is often a temperature range at which the polymer changes from a solid state to a liquid state. The melting temperature may be determined by using a differential scanning calorimeter (DSC) which determines the melting point by measuring the energy input needed to increase the temperature of a sample at a constant rate of temperature change, and wherein the point of maximum energy input determines the melting point of the polymer being evaluated.

For the purposes of the present invention, the term “softening point” refers to a temperature or range of temperatures at which a polymer is or becomes shapeable, moldable, formable, deformable, bendable, extrudable, pliable, etc. The term softening point may include, but does not necessarily include, the term melting point.

For the purposes of the present invention, the term “T_{g}” refers to the glass transition temperature of a polymer. The glass transition temperature is the temperature: (a) below which the physical properties of the polymer vary in a manner similar to those of a solid phase (i.e., a glassy state); and (b) above which the polymer behaves like a liquid (i.e., a rubbery state).

For the purposes of the present invention, the terms “polylactic acid polymer,” “polylactide polymer” or “PLA polymer” refer interchangeably to a biodegradable, thermoplastic, aliphatic polyester which may be formed from a lactic acid or a source of lactic acid, for example, renewable resources such as corn starch, sugarcane, etc. The term PLA polymer may refer to all stereoisomeric forms of PLA polymer, including L- or D-lactides, and racemic mixtures comprising L- and D-lactides. For example, PLA polymers may include D-polylactic acid polymers, L-polylactic acid (also known as PLLA) polymers, D,L-polylactic acid polymers, meso-polylactic acid polymers, as well as any combination of D-polylactic acid polymers, L-polylactic acid polymers, D,L-polylactic acid polymers and meso-polylactic acid polymers. PLA polymers useful herein may be relatively pure D-polylactic acid polymer or L-polylactic acid polymer, for example, at least about 70% by weight, such as at least about 85% by weight, e.g., at least about 95% by weight of either D-polylactic acid polymer or L-polylactic acid polymer (e.g., from about 72 to about 99% by weight of either D-polylactic acid polymer or L-polylactic acid polymer), etc. PLA polymers useful herein may have, for example, a number average molecular weight in the range of from about 15,000 and about 300,000. In preparing the PLA polymers, bacterial fermentation may be used to produce lactic acid, which may be oligomerized and then catalytically dimerized to provide the monomer for ring-opening polymerization. The PLA polymer may be prepared in a high molecular weight form through ring-opening polymerization of the monomer using, for example, a stannous octanoate catalyst, tin(II) chloride, etc. Suitable PLA polymers may include any PLA polymer which may be crystallized (i.e., is not permanently amorphous), such as Ingeo™ 4032D PLA, Ingeo™ 4043D, Ingeo™ 2003D PLA, etc., sold by NatureWorks LLC.

For the purposes of the present invention, the term “polyhydroxyalkanoates (PHAs)” refers broadly to biodegradable, thermoplastic, aliphatic polyesters which may be produced by polymerization of the respective monomer hydroxy aliphatic acids (including dimers of the hydroxy aliphatic acids), by bacterial fermentation of starch, sugars, lipids, etc. PHAs may include one or more of: poly-beta-hydroxybutyrate (PHB) (also known as poly-3-hydroxybutyrate); poly-alpha-hydroxybutyrate (also known as poly-2-hydroxybutyrate); poly-3-hydroxypropionate; poly-3-hydroxyvalerate; poly-4-hydroxybutyrate; poly-4-hydroxyvalerate; poly-5-hydroxyvalerate; poly-3-hydroxyhexanoate; poly-4-hydroxyhexanoate; poly-6-hydroxyhexanoate; polyhydroxybutyrate-valerate (PHBV); copolymers, blends, mixtures, combinations, etc., of different PHA polymers, etc. PHAs may be synthesized by methods disclosed in, for example, U.S. Pat. No. 7,267,794 (Kozaki et al.), issued Sep. 11, 2007; U.S. Pat. No. 7,276,361 (Doi et al.), issued Oct. 2, 2007; U.S. Pat. No. 7,208,535 (Asrar et al.), issued Apr. 24, 2007; U.S. Pat. No. 7,176,349 (Dhugga et al.), issued Feb. 13, 2007; and U.S. Pat. No. 7,025,908 (Williams et al.), issued Apr. 11, 2006, the entire disclosure and contents of the foregoing documents being herein incorporated by reference.

For the purposes of the present invention, the term “mineral filler” refers to inorganic materials, often in particulate form, which may lower cost (per weight) of the polymer, and which, at lower temperatures, may be used to increase the stiffness and decrease the elongation to break of the polymer, and which, at higher temperatures, may be used to increase the viscosity of the polymer melt. Mineral fillers which may used in embodiments of the process of the present invention may include, for example, talc, calcium chloride, titanium dioxide, clay, synthetic clay, gypsum, calcium carbonate, magnesium carbonate, calcium hydroxide, calcium aluminate, magnesium carbonate mica, silica, alumina, sand, gravel, sandstone, limestone, crushed rock, bauxite, granite, limestone, glass beads, aerogels, xerogels, fly ash, fumed silica, fused silica, tabular alumina, kaolin, microspheres, hollow glass spheres, porous ceramic spheres, ceramic materials, pozzolanic materials, zirconium compounds, xonotlite (a crystalline calcium silicate gel), lightweight expanded clays, perlite, vermiculite, hydrated or unhydrated hydraulic cement particles, pumice, zeolites, exfoliated rock, etc., and mixtures thereof. Some mineral fillers (e.g., talc, calcium carbonate, etc.) may also function as polylactic acid polymer nucleating agents.

For the purposes of the present invention, the term “heat resistant article” refers to an article which comprises one or more heat resistant polymers.

For the purposes of the present invention, the term “heat resistant polymer” refers to a polymer (or polymers) which has an HDI value of greater than about 70° C., for example, about 75° C., e.g., in the range of from about 82.2° to about 100° C. (from about 180° to about 212° F.). In other words, these heat resistant polymers are resistant to deformation at temperatures above about 70° C., for example, above about 75° C., e.g., in the range of from about 82.2° to about 100° C. (from about 180° to about 212° F.), for example, can withstand deformation in the presence of hot beverages (e.g., hot coffee).

For the purposes of the present invention, the term “sheet” refers to webs, strips, films, pages, pieces, segments, etc., which may be continuous in form (e.g., webs) for subsequent subdividing into discrete units, or which may be in the form of discrete units (e.g., pieces).

For the purposes of the present invention, the term “extrusion” refers to a method for shaping, molding, forming, etc., a material by forcing, pressing, pushing, etc., the material through a shaping, forming, etc., device having an orifice, slit, etc., for example, a die, etc., to form a sheet. Extrusion may be continuous (producing indefinitely long material) or semi-continuous (producing many shorter pieces, segments, etc.).

For the purposes of the present invention, the term “thermoplastic” refers to the conventional meaning of thermoplastic, i.e., a composition, compound, material, polymer, etc., that exhibits the property of a material, such as a high polymer, that softens when exposed to sufficient heat and generally returns to its original condition when cooled to room temperature (e.g., 20°-25° C.).

For the purposes of the present invention, the term “mil(s)” is used in the conventional sense of referring to thousandths of an inch.

For the purposes of the present invention, the term “polylactic acid polymer nucleating agent” refers to a composition, compound, etc., which induces the formation of polymer crystals (i.e., causes crystallinity to occur) in a polylactic acid (PLA) polymer. Suitable polylactic acid polymer nucleating agents may include one or more of: inorganic nucleating agents such as talc (e.g., MICROTUFF® AGD 609 sold by Mineral Technologies, Inc.), silicate, clay, titanium dioxide, montmorillonite, synthetic mica, zeolite, magnesium oxide, calcium sulfide, calcium carbonate, boron nitride, neodymium oxide, etc.; organic nucleating agents such as dimers of lactic acid (e.g., PURALACT® D sold by Purac), 12-hydroxystearic acid triglyceride, 12-hydroxystearic acid diglyceride, 12-hydroxystearic acid monoglyceride, pentaerythritol-mono-12-hydroxystearate, pentaerythritol-di-12-hydroxystearate, pentaerythritol-tri-12-hydroxystearate, etc., metal salts of organic carboxylic acids such as calcium lactate, sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminium dibenzoate, potassium dibenzoate, lithium dibenzoate, carboxylic acid amides such as stearic acid amide, ethylene bis-carboxyli acid amides, such as ethylene bis-lauric acid amide, ethylene bis-stearic acid amide, palmitic acid amide, hydroxystearic acid amide, erucic acid amide, tris-(alkyl or cycloalkylamide)trimesates, such as tris-(t-butylamide)trimesate, tris-(cyclohexylamide)trimesate; etc. These nucleating agents may be in the form of finely divided solids having, for example, a median particle size of less than about 5 microns, such as less than about 1 microns. One or more of these nucleating agents may also be formulated with the polylactic acid polymer as masterbatch compounds. The nucleating agents (inorganic and/or organic) may also be selected such that the resulting thermoplastic sheet comprises biodegradable and/or compostable materials.

For the purposes of the present invention, the term “masterbatch compound” refers to a composition comprising at least one polylactic acid (PLA) polymer and at least one polylactic acid polymer nucleating agent. For example, Sukano na S516 is a masterbatch compound comprising a polylactic acid polymer, one or more organic polylactic acid polymer nucleating agents, and possibly one or more inorganic polylactic acid polymer nucleating agents. Masterbatch compounds may also comprise other optional components such as colorants (e.g., pigments, tints, etc.), mineral fillers, etc. Masterbatch compounds may be formulated for use in embodiments of the process of the present invention, for example, in the form of discrete pieces, chunks, chips, flakes, pellets, etc., by using, for example, extruders (e.g., single or twin screw extruders), blenders, roll mills, mixers, etc.

For the purposes of the present invention, the term “crystallization inducing amount” refers to an amount of the polylactic acid polymer nucleating agent sufficient to induce crystallization of a polylactic acid (PLA) polymer. What may constitute a “crystallization inducing amount” may depend upon the polylactic acid (PLA) polymer, the nucleating agent(s) used, the conditions (e.g., temperature) under which the polylactic acid (PLA) polymer is processed, etc. In some embodiments, a crystallization inducing amount of the nucleating agent(s) may be in the range of, for example, from about 5 to about 20% by weight of the mixture, blend, etc., comprising thermoplastic sheet, such as from about 12 to about 15% by weight of the thermoplastic sheet.

For the purposes of the present invention, the term “pliable” refers to a thermoplastic sheet (or section thereof) which is sufficiently flexible, bendable, deformable, formable, malleable, etc., that the thermoplastic sheet (or section thereof) may be shaped during thermoforming.

For the purposes of the present invention, the term “discrete section” with reference to the thermoplastic sheet refers to a particular portion of the sheet which is less than entire sheet. This discrete section may generally have dimensions in terms of length and width corresponding to the dimensions of the cavities, surfaces, etc., of the thermoforming mold which form the thermoformed section from the thermoplastic sheet.

For the purposes of the present invention, the term “thermoforming mold” refers to a device, element, component, etc., used in a thermoforming operation to constrain and shape a pliable section of thermoplastic sheet into one or more shaped articles. Thermoforming molds useful herein are temperature-controlled so as to impart to at least the shaped articles in the thermoformed section a temperature below the Tₘ but above the T_{g} of the polylactic acid polymer to thereby induce crystallization of the polylactic acid polymer in the shaped articles. Temperature control in the thermoforming mold may be achieved, for example, by passing heated or hot fluids such as hot water, polyethylene glycol, silicone, mineral oil, etc., through the mold such that the appropriate temperature is imparted to the shaped articles while present in the mold. For example, these heated or hot fluids may be passed through conduits, channels, etc., in the thermoforming mold which are adjacent to the cavities, surfaces, etc., in the mold which form the shaped articles.

For the purposes of the present invention, the term “shaped article” refers to an article formed in the thermoformed section of the thermoplastic sheet having the distinct shape created by thermoforming mold. Shaped articles which may formed in the thermoformed section may include food or beverage articles, especially food and beverage articles for hot food and beverage use, for example, food and beverage containers and closures for such food and beverage containers, such as beverage cups, lids for such beverage cups, mugs, bottles, food trays (e.g., microwavable food trays), pots, bowls, dishes, plates, etc., food and beverage utensils such as forks, spoons, knives, clam-shell food containers comprising lower and upper component halves, etc., non-food and beverage applications used with other hot materials, for example, bottles filled with other hot fluids; etc.

For the purposes of the present invention, the term “incrementally advancing” refers to advancing each discrete section of the thermoplastic sheet in a series distinct steps or increments.

For the purposes of the present invention, the terms “induce crystallization,” “inducing crystallization” and like terms refer to causing crystallization to occur in the (amorphous) polylactic acid (PLA) polymer.

For the purposes of the present invention, the term “degree of crystallization” refers to how much crystallization has occurred in the polylactic acid (PLA) polymer. The degree of crystallization of the polylactic acid (PLA) polymer may be measured by X-ray diffraction of a sample of the article comprising the polylactic acid (PLA) polymer. X-ray diffraction patterns the polylactic acid (PLA) polymer in the sample may be obtained by using graphite monochromated copper K-alpha radiation with a computer controlled, Bragg-Brentano focusing geometry horizontal diffractometer. The X-ray diffraction patterns may be analyzed using first and second derivative algorithms, after digital filter smoothing (see Golay, Anal. Chem., Volume 36, p. 1627 (1964)), to determine the angular positions and the absolute and relative intensities of each detectable diffraction peak.

For the purposes of the present invention, the terms “continuous,” “continuously,” and like terms, with respect to the thermoplastic sheet refer to a sheet having a relatively long, indefinite length.

For the purposes of the present invention, the term “tempering” refers to processing conditions which enable, permit, allow, facilitate, enhance, increase, control, regulate, etc., the crystallization of the polylactic acid (PLA) polymer, and especially the degree of crystallization, in the thermoformed section.

For the purposes of the present invention, the term “convection cooling” refers to cooling of the thermoformed section of the thermoplastic sheet due to convection of heat away from the thermoformed section by the environment (e.g., room air) surrounding the thermoformed section. The environmental temperature may be room temperature (e.g., 20°-25° C., or may be temperature conditions above or below room temperature.

For the purposes of the present invention, the term “detaching” with respect to shaped articles formed in the thermoformed section refers to separating, cutting out, slicing out, punching, severing, removing, etc., the shaped articles from the remainder of the thermoformed section.

For the purposes of the present invention, the term “sequentially” with respect to performing steps in the process refers to performing the successive steps in a specified (consecutive) order.

### Description

To impart sufficient heat resistance to thermoformed articles (e.g., lids for disposable coffee beverage cups) comprising polylactic acid (PLA) polymers which may be used, for example, with hot beverages (e.g., coffee) requires that the PLA polymer have a sufficient degree of crystallinity, as measured by X-ray diffraction. Thermoformed articles prepared from such PLA polymers may be in an amorphous state having little or no degree of crystallinity. Such thermoformed articles comprising such amorphous PLA polymers have minimal, if any heat resistance at higher temperatures, such as exist with hot beverages such as coffee. As a result, thermoformed articles, such as lids for disposable beverage cups tend to deform undesirably when in contact with such hot beverages.

To impart increased heat resistance to thermoformed articles comprising PLA polymers, amorphous sheets of PLA polymer may be heated until the PLA polymer reaches the desired degree of crystallinity, and thus become a semicrystalline PLA sheet. In other words, crystallinity is attained in this semicrystalline PLA sheet prior to the thermoforming operation. This semicrystalline PLA sheet may then be thermoformed (or alternatively cooled and later reheated to a thermoforming temperature under conditions that maintain the crystallinity of the PLA polymer) with a thermoforming mold held at a relatively cold mold temperature (i.e., below 80° C. (176° F.), preferably below the T_{g} of the PLA polymer in the sheet, and more preferably no greater than 50° C. (122° F.), such as no greater than 35° C. (95° F.)) to form articles, such as microwavable food trays, beverage cups, separate lids or covers for such trays or cups, etc., in the thermoformed sheet. See, for example, U.S. Pat. No. 7,670,545 (Bopp et al.), issued Mar. 2, 2010. Using such pre-crystallized (e.g., semicrystalline) sheets may, however, impair molding of features in the shaped articles so as to provide sufficient detail for those molded features during the thermoforming operation.

Other methods for improving heat resistance in thermoformed articles comprising PLA polymers may rely upon the thermoformed sheet being constrained within a thermoforming mold while being heated or held at a temperature near the T_{g} of the PLA polymer to keep the shaped articles from deforming until sufficient crystallization is achieved in the thermoformed PLA polymer sheet. See, for example, U.S. Pat. No. 8,110,138 (Uradnisheck), issued Feb. 7, 2012 which discloses extruding PLA to produce a film or sheet which is then thermoformed in a heated mold having a temperature greater than or equal about 90° C. (194° F.) to produce a thermoformed article, followed by further heat treatment of the thermoformed article in the heated mold for less than about 40 seconds (e.g., less than about 5 seconds). But retaining the thermoformed PLA sheet within the thermoforming mold to achieve the desired degree of crystallization may decrease the efficiency and throughput of the thermoforming operation.

By contrast, in embodiments according to the process of the present invention, it has been found that the heat resistance of the shaped articles formed in the thermoformed polylactic acid (PLA) polymer sheets may be improved by increasing the degree of crystallization in such thermoformed PLA sheets and especially the shaped articles formed in those sheets during and after the thermoforming operation. As a result, amorphous PLA sheets may be thermoformed into shaped articles having distinct features and fine details. In addition, sufficient crystallization may also be achieved in the shaped articles resulting from the thermoformed PLA sheet without any need to constrain the PLA sheet in the thermoforming mold for any significant period of time (e.g., no more than about 5 seconds in the thermoforming mold) to avoid having the shaped articles deform prior to detaching the articles from the thermoformed sheet by using, for example, a trim press. As a result, the PLA sheet may be processed in a continuous manner to provide thermoformed shaped articles, thus permitting an efficient thermoforming operation with higher throughput.

What has been found is that crystallization of the polylactic acid (PLA) polymer in the amorphous pliable thermoplastic sheet may begin as soon as the temperature of the thermoplastic sheet decreases below the melt temperature (Tₘ) of the PLA polymer and continues until the temperature of the thermoplastic sheet is reduced below the glass transition temperature (T_{g}) of the PLA polymer as the thermoplastic sheet is advanced from the thermoforming mold towards other downstream processing operations. When the thermoplastic sheet reaches the thermoforming mold, crystallization of the PLA polymer in the thermoplastic sheet may be initiated (induced) as the temperature of the thermoplastic sheet decreases in the thermoforming mold to a temperature below the melt temperature (Tₘ) of the PLA polymer. As the temperature of the PLA polymer in the shaped articles of the thermoformed section further decreases towards and eventually below the glass transition temperature (T_{g}) during the tempering operation (i.e., the period of transition between the thermoforming operation and the shaped article detaching operation), the degree of crystallization of the PLA polymer continues to increase in the shaped articles of the thermoformed section until the temperature of the PLA polymer is reduced to at or below the glass transition temperature (T_{g}). In other words, by selecting appropriate processing (temperature) conditions, the temperature of thermoformed section exiting the thermoforming mold can be controlled to, for example, from about 100° to about 200° F. (from about 37.8° to about 93.3° C.), such as from about 140° to about 160° F. (from about 60° to about 71.1° C.), to permit mechanical handling of the thermoformed section without deformation of shaped articles in the thermoformed section, yet sufficiently above T_{g} of the PLA polymer to allow crystallization to continue, it becomes possible to extend the period of crystallization of the PLA polymer in the shaped articles of the thermoformed section as the thermoformed sections advances to downstream operations (e.g., for detaching the shaped articles from the remainder of the thermoformed section) in the process. (The rate of crystallization of the PLA polymer during the tempering operation may also be affected by the amount of nucleating agent(s) present, the thermal history of the thermoformed section after the thermoforming operation, etc.) In fact, further crystallization of the PLA polymer in the detached shaped articles may continue after this detaching operation. As a result, heat resistance of the detached shaped articles may be increased, for example, such that the shaped articles resist deformation at a temperature of, for example, about 180° F. (82.2° C.) or higher, such as up to about 212° F. (100° C.).

In embodiments of the process of the present invention, an amorphous pliable thermoplastic sheet comprising at least about 60% (e.g., at least about 80%, such as at least about 85%) by weight of the thermoplastic sheet of a PLA polymer may be used. In some embodiments of the process of the present invention, the thermoplastic sheet may comprise the PLA polymer and a crystallization inducing amount (e.g., from about 5 to about 20% by weight of the thermoplastic sheet, such as from about 12 to about 15% by weight of the thermoplastic sheet) of at least one PLA polymer nucleating agent. Inclusion of such nucleating agents may increase and/or control the rate at which crystallization of the PLA polymer occurs in the thermoformed section of the thermoplastic sheet. Besides the PLA polymer and nucleating agent(s), the thermoplastic sheet may optionally comprise other components such as colorants (e.g., pigments, tints, etc), mineral fillers, polymers other than PLA such as polyhydroxyalkanoate (PHA) polymers, etc.

In some embodiments of the process of the present invention, the PLA polymer and nucleating agent(s) may be combined separately prior to forming the thermoplastic sheet. In other embodiments, the PLA polymer and nucleating agent(s) may be combined together to form a masterbatch compound (e.g., in the form of pellets, flakes, etc.) that is used to form the thermoplastic sheet. In yet other embodiments, a first masterbatch compound comprising a PLA polymer and an inorganic nucleating agent and second masterbatch compound comprising the same PLA polymer and an organic nucleating agent may be combined (e.g., blended) together in forming the thermoplastic sheet. The use of such first and second masterbatch compounds may be used to adjust the ratio of inorganic nucleating agent(s) to organic nucleating agent(s) present in the blend, as well as to adjust the blend composition in terms of the PLA polymer and nucleating agents when, for example, residual thermoplastic sheet (e.g., regrind from trimmed thermoformed sections) is recycled and included as a portion of the blend composition. For example, in some embodiments of the process of the present invention, the ratio of talc (an inorganic nucleating agent) to Sukano na 516 (comprising at least some organic nucleating agent) in the blend composition may be in a weight ratio of talc:Sukano na S516 in the range of from about 1:2 to about 4.5:1 (e.g., such as about 2.75:1).

In some embodiments of the process of the present invention, the PLA polymer may be continuously extruded to the form the thermoplastic sheet. In some embodiments of the process of the present invention, this continuously extruded thermoplastic sheet may also be optionally passed over a chill roll to impart, for example, a desired surface finish to the extruded thermoplastic sheet, to provide for manufacturing adjustments such as edge trimming of the extruded thermoplastic sheet to a particular width, to increase the ability to handle the extruded thermoplastic sheet in an intermittent (e.g., incremental) motion thermoforming operation, to retard, inhibit, minimize, prevent, etc., the crystallization of the PLA polymer, etc. In some embodiments of the process of the present invention, this continuously extruded thermoplastic sheet (with or without being passed over a chill roll) may then be heated (e.g., by passing through an oven) to a temperature, for example, at or above the Tₘ of the PLA polymer (e.g., at least about 250° F. (121.1° C.), for example, as at least about 300° F. (148.9° C.), such as from about 300° to about 450° F. (from about 148.9° to about 232.2° C.)) to provide an amorphous pliable thermoplastic sheet.

This amorphous pliable thermoplastic sheet may then be thermoformed in a temperature-controlled thermoforming mold to provide a discrete thermoformed section having one or more shaped articles formed therein and to impart to the shaped articles in the thermoformed section a temperature below the Tₘ but above the T_{g} of the PLA polymer (e.g., from about 100° to about 200° F. (from about 37.8° to about 93.3° C.), such as from about 140° to about 160° F. (from about 60° to about 71.1° C.)). In addition, by thermoforming the thermoplastic sheet in the thermoforming mold to a temperature below the Tₘ but above the T_{g}, crystallization of the PLA polymer (especially in the presence of a nucleating agent(s)) is induced in the shaped articles in thermoformed sections.

In some embodiments of the process of the present invention, this amorphous pliable thermoplastic sheet may be incrementally advanced as discrete sections into the thermoforming mold in the thermoforming operation. Such incremental advancement may occur, for example, at a rate of from about 5 to about 30 cycles per minute, such as from about 20 to about 26 cycles per minute. As a result, thermoforming of the thermoplastic sheet in the thermoforming mold may occur, for example, in from about 0.2 to about 5 seconds, such as from about 0.5 to about 1.5 seconds, to form the shaped articles in the thermoformed section.

After the thermoforming operation, the thermoformed section is released from the thermoforming mold such that the shaped articles in the thermoformed section are unconstrained. While unconstrained by the thermoforming mold, each discrete thermoformed section is then subjected to a tempering operation (e.g., by convection cooling) at a temperature above the T_{g} of the PLA polymer such that the PLA polymer in the unconstrained shaped articles achieves a degree of crystallization of at least about 5% (e.g., from 5 to about 45%), such as at least about 8%, (e.g., from about 8 to about 20%), as measured by X-ray diffraction.

After the tempering operation to achieve a sufficient degree of crystallization of the PLA polymer in the unconstrained shaped articles, the thermoformed section may then be advanced (e.g., incrementally advanced) to a detaching operation to separate the shaped articles from the remainder of the thermoformed section. (In some embodiments, the time period for carrying out the tempering operation of the thermoformed section between the thermoforming operation and the detaching operation may be, for example, be in the range of from about 10 to about 30 seconds, such as from about 15 to about 20 seconds.) The detaching operation may be carried out, for example, by using a trim press to detach (e.g., cut out) the plurality of shaped articles from the remaining portion of the thermoformed section.

An embodiment of the process according to the present invention for preparing a thermoformed article comprising a PLA polymer is schematically illustrated in the FIGURE which is indicated generally as 100. In process 100, a PLA polymer (Polymer 102), as indicated by arrow 104, an inorganic PLA polymer nucleating agent, such as talc (Inorganic Nucleating Agent 106), as indicated by arrow 108, and an organic PLA polymer nucleating agent, such as Sukano na 516 (Organic Nucleating Agent 110), as indicated by arrow 112, may be added to Blender/Feeder 114 to form a mixture, blend, etc. In some embodiments of process 100, Inorganic Nucleating 106 and/or Organic Nucleating Agent 110 may be in the form of a masterbatch compound where the nucleating agent is combined with the PLA polymer to provide, for example, a pellet, flake, etc., which may be used to control the proportions of Polymer 102, Inorganic Nucleating 106, and Organic Nucleating Agent 110 present in the mixture in Blender/Feeder 114.

The mixture, blend, etc., from Blender/Feeder 114, as indicated by arrow 116, may be passed through Extruder 118 to form a continuous thermoplastic sheet. Extruder 118 may be a single screw extruder, a twin (double) screw extruder, etc. The thermoplastic sheet formed by Extruder 118 may have any desired width, for example, in the range of from about 3 to about 70 inches (from about 7.6 to about 177.8 cm), such as from about 30 to about 40 inches (from about 76.2 to about 101.6 cm). As indicated by arrow 120, the thermoplastic sheet formed by Extruder 118 may then be passed over Chill Roll 122. As indicated by arrow 124, the thermoplastic sheet from Chill Roll 122 may then be passed through Oven 126 which heats the thermoplastic sheet to a temperature (e.g., from about 300° to about 400° F. (from about 148.9° to about 204.4° C., such as about 380° F. (193.3° C.)) at or above the Tₘ of the PLA polymer to provide an amorphous thermoplastic sheet which is sufficiently pliable to be subsequently thermoformed with acceptable detail (i.e., the features of the subsequently formed shaped articles are sufficiently distinct). In some embodiments of process 100, the thermoplastic sheet passing over Chill Roll 122 may be wound up, for example, as a roll of thermoplastic sheet, such that Blender/Feeder step 114 and Chill Roll 122 are thermoplastic sheet forming operations which are separate from the thermoforming operation that begins with Oven 126. This roll of thermoplastic sheet formed by the sheet formation operation may then be later unwound and passed through Oven 126 to begin the thermoforming operation. In other embodiments, process 100 is continuous from Blender/Feeder step 114 through Chill Roll 122, through Oven 126, and beyond to other downstream processing operations.

As indicated by arrow 128, the amorphous pliable thermoplastic sheet from Oven 126 may then be incrementally advanced as discrete sections into a temperature-controlled thermoforming mold (Thermoformer 130). A temperature-controlled fluid (e.g., hot water) may be passed through the Thermoformer 130 to impart to the discrete section of the thermoplastic sheet a temperature (e.g., 110°-185° F. (37.8°-85° C.)) below the Tₘ but above the T_{g} of the polylactic acid polymer. As a result, Thermoformer 130 creates a discrete thermoformed section having a plurality of discrete shaped articles formed therein (e.g., a 6×6 array of 36 shaped beverage lids, although other arrays of shaped articles may also be formed in the thermoformed section such as 3×6 array of 18 shaped articles, 3×10 array of 30 shaped articles, etc.). In addition, because of the temperature-controlled fluid passing through the Thermoformer 130, Thermoformer 130 induces crystallization of the polylactic acid polymer in the shaped articles formed in the thermoformed section. The thermoformed sections may be of any length corresponding to that of Thermoformer 130. For example, the thermoformed section may have a length in the range of from about 12 to about 70 inches (from about 30.5 to about 177.8 cm), such as from about 30 to about 50 inches (from about 76.2 to about 127 cm).

As indicated by arrow 132, the thermoformed section from Thermoformer 130 may then be advanced towards Trim Press 134 to undergo a tempering operation. During the advance of the thermoformed section towards Trim Press 134, tempering step 132 may be carried out, for example, by natural convection cooling (e.g., under room temperature conditions) of the thermoformed section so that the PLA polymer in the shaped articles undergoes the desired degree of crystallization. Alternatively, tempering step 132 may be carried out by altering and/or controlling the heat flux that the thermoformed section is subjected to (e.g., by using forced convection and/or infrared heaters) to control the rate and/or extent of crystallization of the PLA polymer present in the shaped articles. As indicated by arrow 136, when the thermoformed section reaches Trim Press 134, the shaped articles (Articles 138) may then be cut out from the thermoformed section by Trim Press 134. Steps 126 and 132 may be repeated sequentially a plurality of times as the thermoplastic sheet is advanced incrementally to Thermoformer 130 and then to Trim Press 134.

As indicated by dashed arrow 140, the residual thermoformed section from Trim Press 134 after Articles 138 are cut out may be recycled as Regrind 142. As indicated by dashed arrow 144, Regrind 142 may be added to Blender/Feeder 114, along with Polymer 102, Inorganic Nucleating Agent 106, and Organic Nucleating Agent 110. When Regrind 142 is added to Blender/Feeder 114, formulation of Polymer 102, Inorganic Nucleating Agent 106, and Organic Nucleating Agent 110 as masterbatch compounds may be used to control the proportion of polylactic acid polymer and nucleating agents present in the mixture in Blender/Feeder 114.

### Examples

The following example illustrates one specific embodiment of the process of the present invention.

Masterbatch Compounding:

A masterbatch compound comprising 50% by weight polylactic acid (PLA) 4032D polymer and 50% by weight talc is prepared by using a co-rotating twin screw extruder, Brabender feeder, and Gala underwater pelletizer with a die face cutter to provide PLA/talc masterbatch compound pellets. A desiccant dryer is used to dry the PLA/talc pellets.

Thermoforming Equipment:

A Maguire gravimetric blender/feeder is used to feed PLA 4032D polymer, Sukano na S516 nucleating agent, and PLA/talc pellets into an extruder to provide a blend mixture comprising, for example, 81.3% PLA, 13.7% talc, and 5% Sukano na S516 nucleating agent. A Battenfeld Gloucester single screw extruder is used to mix these three materials at, for example, 380° F. (193.3° C.) to convert the mixed materials into a melt that provides 17-mil thick, 19.5″ wide thermoplastic sheet. The thermoplastic sheet is thermoformed into beverage cup lids with a Brown Thermoforming Machine using a male thermoforming mold. The thermoforming mold is controlled to an appropriate temperature (e.g., at 110° F. (43.3° C.), 130° F. (54.4° C.), 170° F. (76.7° C.), or 185° F. (85° C.)) by circulating hot water in the mold channels. The thermoforming mold process temperature may be monitored by measuring the sheet temperature (e.g., 144°-154° F. (66.2°-67.8° C.)) exiting from the mold box. Thermoforming is carried out by incrementally advancing the thermoplastic sheet to the thermoforming mold at a rate of 10 or 22 cycles per minute (CPM). Sipper- and vent-holes are punched out in the shaped lids while the shaped lids are trimmed from the remainder of the thermoformed section the sheet at a trim press. This remaining portion of the trimmed thermoformed section may be ground to provide regrind and fed back to the extruder, along with the PLA 4032 polymer, Sukano na S516 nucleating agent, and PLA/talc pellets in preparing additional extruded thermoplastic sheet.

The thermoforming conditions for the various runs (Run 1-4) are shown in Table 1 below:

TABLE 1
Thermoforming Conditions

| | Cycles per | | |
|---|---|---|---|
| | minute | Mold | |
| Run | (CPM) | Temperature | Sheet exit temperature |
| 1 | 10 | 185° F. (85° C.) | 150°-154° F. (65.6°-67.8° C.) |
| 2 | 10 | 170° F. (76.7° C.) | 150°-154° F. (65.6°-67.8° C.) |
| 3 | 10 | 130° F. (54.4° C.) | 150°-154° F. (65.6°-67.8° C.) |
| 4 | 22 | 110° F. (43.3° C.) | 144°-154° F. (66.2°-67.8° C.) |

The shaped lids from Runs 1 through 4 are found to have adequate heat resistance in that the lids do not deform in the presence of hot beverage fluid, e.g., temperature of from about 180° to about 212° F. (from about 82.2° to about 100° C.)

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A process for increasing the heat resistance of shaped thermoformed articles made from a thermoplastic sheet, comprising the following steps:
(a) providing an amorphous pliable thermoplastic sheet comprising at least about 60% by weight of the amorphous pliable thermoplastic sheet of a polylactic acid polymer;
(b) thermoforming a discrete section of the amorphous pliable thermoplastic sheet in a temperature-controlled thermoforming mold to provide a discrete thermoformed section having one or more shaped articles formed therein and to impart to the shaped articles a temperature below the Tₘ but above the T_{g} of the polylactic acid polymer to thereby induce crystallization of the polylactic acid polymer in the shaped articles; and
(c) while unconstrained by the thermoforming mold, tempering the thermoformed section at a temperature above the T_{g} of the polylactic acid polymer such that the polylactic acid polymer in the shaped articles achieves a degree of crystallization of at least about 5% (as measured by X-ray diffraction) to thereby increase the heat resistance of the shaped articles.

2. The process of claim 1, wherein the polylactic acid polymer comprises at least about 70% by weight L-polylactic acid polymer or D-polylactic acid polymer.

3. The process of claim 2, wherein the polylactic acid polymer comprises at least about 85% by weight L-polylactic acid polymer or D-polylactic acid polymer.

4. The process of claim 2, wherein the polylactic acid polymer comprises from about 72 to about 99% by weight L-polylactic acid polymer or D-polylactic acid polymer.

5. The process of claim 1, which comprises the further step (d) of extruding the thermoplastic sheet prior to step (a) and wherein the extruded thermoplastic sheet comprises a crystallization inducing amount of at least one polylactic acid polymer nucleating agent.

6. The process of claim 1, wherein step (a) is carried out by heating the thermoplastic sheet to a temperature at or above the Tₘ of the polylactic acid polymer.

7. The process of claim 6, wherein step (a) is carried out by heating the thermoplastic sheet to a temperature of at least about 250° F.

8. The process of claim 7, wherein step (a) is carried out by heating the thermoplastic sheet to a temperature of from about 300° to about 450° F.

9. The process of claim 1, wherein step (b) is carried out by incrementally advancing the discrete section of the amorphous pliable thermoplastic sheet into the thermoforming mold to impart to the shaped articles in the thermoformed section a temperature of from about 100° to about 200° F. for a period of from about 0.2 to about 5 seconds.

10. The process of claim 9, wherein the temperature imparted to the shaped articles in the thermoformed section in the thermoforming mold during step (b) is from about 140° to about 160° F. for a period of from about 0.5 to about 1.5 seconds.

11. The process of claim 1, wherein a plurality of shaped articles are formed in the thermoformed section during step (b).

12. The process of claim 11 which comprises the further step (e) of detaching the shaped articles from the thermoformed section.

13. The process of claim 12, wherein step (c) is carried out by cutting out the shaped articles from the thermoformed section.

14. The process of claim 11, wherein the shaped articles are beverage cup lids.

15. The process of claim 1, wherein step (c) is carried out by convection cooling of the discrete thermoformed section.

16. The process of claim 1, wherein steps (b) and (c) are repeated sequentially at least once.

17. The process of claim 16, wherein steps (b) and (c) are repeated sequentially at a rate of from about 5 to about 30 cycles per minute.

18. The process of claim 17, wherein steps (b) and (c) are repeated sequentially at a rate of from about 20 to about 26 cycles per minute.

19. The process of claim 1, wherein step (c) is carried out such that the polylactic acid polymer in the shaped articles achieves a degree of crystallization of from about 5 to about 45% (as measured by X-ray diffraction).

20. The process of claim 1, wherein step (c) is carried out such that the polylactic acid polymer in the shaped articles achieves a degree of crystallization of at least about 8% (as measured by X-ray diffraction).

21. The process of claim 20, wherein step (c) is carried out such that the polylactic acid polymer in the shaped articles achieves a degree of crystallization of from about 8 to about 20% (as measured by X-ray diffraction).

22. The process of claim 1, wherein the thermoplastic sheet of step (a) comprises at least about 80% by weight polylactic acid polymer and from about 5 to about 20% by weight of a polylactic acid polymer nucleating agent.

23. The process of claim 22, wherein the thermoplastic sheet of step (a) comprises at least about 85% by weight polylactic acid polymer and from about 12 to about 15% by weight of a polylactic acid polymer nucleating agent.

24. The process of claim 22, wherein the polylactic acid polymer nucleating agent comprises talc.

25. The process of claim 24, wherein the polylactic acid polymer nucleating agent comprises talc and Sukano na S516 in a weight ratio of talc:Sukano na S516 of from about 1:2 to about 4.5:1.

26. The process of claim 1, wherein the tempering in step (c) is carried out for from about 10 to about 30 seconds.

27. The process of claim 26, wherein the tempering in step (c) is carried out for from about 15 to about 20 seconds.

28. The process of claim 1, wherein the amorphous pliable thermoplastic sheet of step (a) is formed by combining a first master compound comprising polylactic acid polymer and an inorganic polylactic acid polymer nucleating agent and a second first master compound comprising polylactic acid polymer and an organic polylactic acid polymer nucleating agent.

29. A process for manufacturing shaped thermoformed articles having improved heat resistance from a thermoplastic sheet, comprising the following steps:
(a) continuously extruding a thermoplastic sheet comprising a least about 60% by weight of the thermoplastic sheet of a polylactic acid polymer and a crystallization inducing amount of at least one polylactic acid polymer nucleating agent;
(b) heating the thermoplastic sheet of step (a) to a temperature at or above the Tₘ of the polylactic acid polymer to provide an amorphous pliable thermoplastic sheet;
(c) incrementally advancing a discrete section of the amorphous pliable thermoplastic sheet into a temperature-controlled thermoforming mold to provide a discrete thermoformed section having a plurality of shaped articles formed therein and to impart to the shaped articles a temperature below the Tₘ but above the T_{g} of the polylactic acid polymer to thereby induce crystallization of the polylactic acid polymer in the shaped articles;
(d) while unconstrained by the thermoforming mold, convection cooling the thermoformed section at a temperature above the T_{g} of the polylactic acid polymer such that the polylactic acid polymer in the shaped articles achieves a degree of crystallization of at least about 5% (as measured by X-ray diffraction) to thereby increase the heat resistance of the shaped articles; and
(e) after step (d), detaching each of the shaped articles from the thermoformed section;
wherein steps (b) through (e) are performed sequentially a plurality of times.

30. The process of claim 29, wherein the polylactic acid polymer comprises at least about 70% by weight L-polylactic acid polymer or D-polylactic acid polymer.

31. The process of claim 30, wherein the polylactic acid polymer comprises at least about 85% by weight L-polylactic acid polymer or D-polylactic acid polymer.

32. The process of claim 30, wherein the polylactic acid polymer comprises from about 72 to about 99% by weight L-polylactic acid polymer or D-polylactic acid polymer.

33. The process of claim 29, wherein step (b) is carried out by heating the thermoplastic sheet to a temperature of at least about 250° F.

34. The process of claim 33, wherein step (b) is carried out by heating the thermoplastic sheet to a temperature of from about 300° to about 450° F.

35. The process of claim 29, wherein the shaped articles in the thermoformed section are heated in the thermoforming mold during step (c) to a temperature of from about 100° to about 200° F. for a period of from about 0.2 to about 5 seconds.

36. The process of claim 35, wherein the temperature imparted to the shaped articles in the thermoformed section in the thermoforming mold during step (c) is from about 140° to about 160° F. for a period of from about 0.5 to about 1.5 seconds.

37. The process of claim 29, wherein step (e) is carried out by cutting out the shaped articles from the thermoformed section.

38. The process of claim 37, wherein step (e) generates a residual thermoformed section after cutting out the shaped articles, and which comprises the further step (f) of recycling the residual thermoformed section when continuously extruding a thermoplastic sheet during step (a).

39. The process of claim 29, wherein steps (b) through (d) are repeated sequentially at a rate of from about 5 to about 30 cycles per minute.

40. The process of claim 39, wherein steps (b) through (d) are repeated sequentially at a rate of from about 20 to about 26 cycles per minute.

41. The process of claim 29, wherein step (d) is carried out such that the polylactic acid polymer in the shaped articles achieves a degree of crystallization of from about 5 to about 45% (as measured by X-ray diffraction).

42. The process of claim 29, wherein step (d) is carried out such that the polylactic acid polymer in the shaped articles achieves a degree of crystallization of at least about 8% (as measured by X-ray diffraction).

43. The process of claim 42, wherein step (d) is carried out such that the polylactic acid polymer in the shaped articles achieves a degree of crystallization of from about 8 to about 20% (as measured by X-ray diffraction).

44. The process of claim 29, wherein the thermoplastic sheet of step (a) comprises at least about 80% by weight polylactic acid polymer and from about 5 to about 20% by weight of a polylactic acid polymer nucleating agent.

45. The process of claim 44, wherein the thermoplastic sheet of step (a) comprises at least about 85% by weight polylactic acid polymer and from about 12 to about 15% by weight of a polylactic acid polymer nucleating agent.

46. The process of claim 45, wherein the polylactic acid polymer nucleating agent comprises talc.

47. The process of claim 46, wherein the polylactic acid polymer nucleating agent comprises talc and Sukano na S516 in a weight ratio of talc:Sukano na S516 of from about 1:2 to about 4.5:1.

48. The process of claim 29, wherein the convection cooling in step (d) is carried out for from about 10 to about 30 seconds.

49. The process of claim 48, wherein the convection cooling in step (d) is carried out for from about 15 to about 20 seconds.

50. The process of claim 29, wherein the thermoplastic sheet of step (a) is formed by continuously extruding a blend of a first master compound comprising polylactic acid polymer and an inorganic polylactic acid polymer nucleating agent and a second first master compound comprising polylactic acid polymer and an organic polylactic acid polymer nucleating agent.
